(19) United States
(12) Patent Application Publication
(10) Pub. No.: US 2017/0046668 A1
(43) Pub. Date: Feb. 16, 2017

(54) Comparing An Extracted User Name with Stored User Data

(71) Applicant: GOOGLE INC., Mountain View, CA (US)

(72) Inventors: Henry Allan Rowley, Sunnyvale, CA (US); Sanjiv Kumar, White Plains, NY (US); Xiaofeng Liu, Scarsdale, NY (US); Brian Lin Chang, San Francisco, CA (US); Daniel Niels Holtmann-Rice, New York, NY (US)

(21) Appl. No.: 14/827,330

(22) Filed: Aug. 16, 2015

(51) Int. Cl. G06Q 20/10; G06Q 20/36; G06K 9/20

(52) U.S. Cl. CPC G06Q 20/10; G06K 9/2063; G06Q 20/36; G06K 2209/01

(57) ABSTRACT

An application extracts a user name from a financial card image using optical character recognition (“OCR”) and compares segments of the user name to names stored in user data to refine the extracted name. The application performs an OCR algorithm on a card image and compares an extracted name with user data. The application identifies likely matching names to the extracted name. The OCR application breaks the extracted name into one or more series of segments and compares the segments from the extracted name to segments from the stored names. The OCR application determines an edit distance between the extracted name and each potentially matching stored name. If the edit distance is below a configured threshold then the OCR application revises the extracted name to match the identified stored name. The refined name is presented to the user for verification.

### TECHNICAL FIELD

The technology disclosed herein pertains to extracting a user name from a financial card and comparing segments of the user name to names stored in user data to refine the extracted name.

### BACKGROUND

When consumers make online purchases or purchases using mobile devices, they are often forced to enter credit card information into the mobile device for payment. Due to the small screen size and keyboard interface on a mobile device, such entry is generally cumbersome and prone to errors. Users may use many different cards for purchases, such as credit cards, debit cards, stored value cards, and other cards. Information entry difficulties are multiplied for a merchant attempting to process mobile payments on mobile devices for multiple transactions.

Current applications for using optical character recognition (“OCR”) applications for obtaining payment information from a payment card do not utilize other available data, such as names and contacts stored in user data, to revise the extracted name.

### SUMMARY

Techniques herein provide computer-implemented methods to allow a user computing device to extract a user name from a financial card image using optical character recognition (“OCR”) and comparing segments of the user name to names stored in user data to refine the extracted name. An OCR application captures an image of the card and performs an OCR algorithm on the card image. The OCR application identifies a list of potentially matching stored names. The OCR application breaks the extracted name into one or more series of segments and compares the segments from the extracted name to segments from the stored names. The OCR application determines an edit distance between the extracted name and each potentially matching stored name. An overall edit distance is calculated by factoring in an edit distance for each segment and an edit distance between segments. After identifying the series with the lowest overall edit distance, the OCR application compares the edit distance with a configured threshold. If the edit distance is below the threshold then the OCR application revises the extracted name to match the identified stored name. The refined name is presented to the user for verification.

In certain other example aspects described herein, systems and computer program products to extract a user name from a financial card and compare segments of the user name to names stored in user data to refine the extracted name.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to use stored user names to verify and correct extracted user names, in accordance with certain example embodiments of the technology disclosed herein.

FIG. 2 is a block flow diagram depicting methods to use stored user names to verify and correct extracted user names, in accordance with certain example embodiments.

FIG. 3 is a block flow diagram depicting methods to compare extracted name to analyzed user data, in accordance with certain example embodiments.

FIG. 4 is an illustration of a user computing device displaying an image of a financial card, in accordance with certain example embodiments.

FIG. 5 is a block diagram depicting a computing machine and a module, in accordance with certain example embodiments.

### DETAILED DESCRIPTION OF THE EXAMPLE EMBODIMENTS

### Overview

Embodiments herein provide computer-implemented techniques to allow a user computing device to extract a user name from a financial card image using optical character recognition (“OCR”) and comparing segments of the user name to names stored in user data to refine the extracted name.

The user employs a mobile phone, digital camera, or other user computing device to capture an image of a card associated with the account that the user desires to input into the user computing device. An OCR application operating on the user computing device or a server associated with the user computing device receives the image of the card. The OCR application performs an OCR algorithm on the card image and compares an extracted name with user data stored on the user computing device or in any related accounts associated with the user, such as a contact database, user financial accounts, a digital wallet account, or any other suitable user data. The OCR application identifies a list of potentially matching stored names.

The OCR application breaks the extracted name into one or more series of segments. In an example, the segments are broken at each space in the extracted name. For example, in the name John A Smith, the segments might be broken into three segments, such as Jon/A/Smith. The stored names identified in the name recognition algorithm are broken into segments in a similar manner.

The OCR application compares the segments from the extracted name to the segments from the stored names. The OCR application determines an edit distance between each set of names in the comparison. For example, if the first segment of a stored name is Jan, then the edit distance would be one letter. That is, changing the single letter “o” in Jon to an “a” would produce the stored name segment “Jan.” An overall edit distance may be calculated by factoring in an edit distance for each segment and an edit distance between segments. For example, if two of the three segments match perfectly, but one segment requires edits, then the edit distance between segments would be one segment.

In another example, an overall edit distance may be calculated by summing the edit distance for each segment. In another example, segments that do not have a corresponding segment in a compared name do not contribute to the overall edit distance. In another example, skipped segments from the stored name do not contribute to the overall edit distance, but extracted segments that do not have a corresponding stored name segment do contribute to the overall edit distance.

In another example, additional segment splits may be identified for the extracted name. For example, Jon A Smith may be segmented into Jon/A Smith, Jon A/Smith, or Jon/A/Smith or any other suitable grouping of segments.

In another example, certain letters may be worn off of the financial card and leave spaces in the extracted name, such as with the extracted name Jon A Sm th. The OCR application may divide the example extracted name into 1, 2, 3, or 4 segments. After comparison with the stored names, the number of segments that produces the lowest edit distance may be utilized.

After identifying the series with the shortest overall edit distance, the OCR application compares the edit distance with a configured threshold. If the edit distance is below the threshold, then the OCR application revises the extracted name to match the identified stored name. The revised name is presented to the user for verification. The revised name is communicated to the application or system that will utilize the user name, such as the digital wallet application.

In certain examples, the extracted name is not revised to reflect the complete stored name. That is, the overall edit distance is not used to only accept or reject revision. Instead, individual extracted name segments may be revised if the individual extracted name segment has an edit distance below a configured threshold. Revising individual segments allows partial matches to be used. In an example, a user scans a spouse's card using a user device. If the last name segment on the card matches the last name of an account name on a cell phone account associated with the user device, the OCR application will perform a correction on the last name segment. However, if the first name does not match below a threshold, the first name will not be revised.

By using and relying on the methods and systems described herein, an OCR application, OCR system, a user computing device, or other computing system extracts a user name from a financial card and compares segments of the user name to names stored in user data to improve the extraction process by refining the name. As such, the systems and methods described herein may be employed to allow the computing device to utilize user data, such as contact applications and account names, to verify and revise suggested user names before presentation to a user. Relying on the user data to improve the extraction process allows the computing device to provide more accurate and precise data extraction to the user. The improved extraction will allow the user to shorten the time and lessen the effort required to input financial card data into a digital wallet or other suitable application.

### Example System Architecture

Turning now to the drawings, in which like numerals represent like (but not necessarily identical) elements throughout the figures, example embodiments are described in detail.

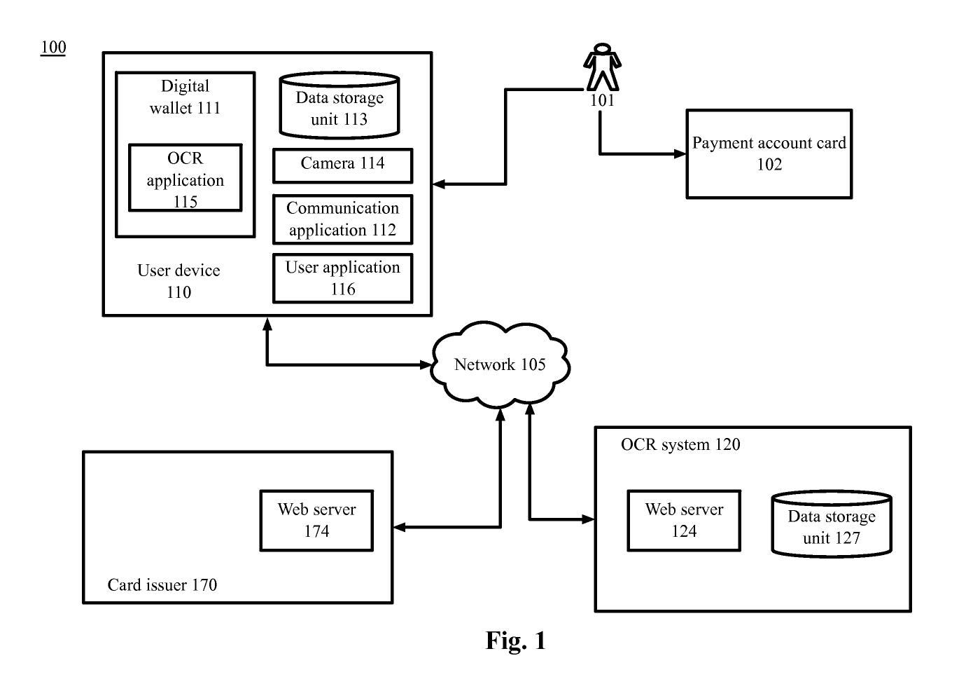

FIG. 1 is a block diagram depicting a system to use stored user names to verify and correct extracted user names, in accordance with certain example embodiments.

As depicted in FIG. 1, the system 100 includes network computing devices 110, 120, and 170 that are configured to communicate with one another via one or more networks 105. In some embodiments, a user 101 associated with a device must install an application and/or make a feature selection to obtain the benefits of the techniques described herein.

Each network 105 includes a wired or wireless telecommunication means by which network devices (including devices 110, 120, and 170) can exchange data. For example, each network 105 can include a local area network (“LAN”), a wide area network (“WAN”), an intranet, an Internet, a mobile telephone network, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals or data. Throughout the discussion of example embodiments, it should be understood that the terms “data” and “information” are used interchangeably herein to refer to text, images, audio, video, or any other form of information that can exist in a computer-based environment. The communication technology utilized by the devices 110, 120, and 170 may be similar networks to network 105 or an alternative communication technology.

Each network computing device 110, 120, and 170 includes a device having a communication module capable of transmitting and receiving data over the network 105. For example, each network device 110, 120, and 170 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 110, 120, and 170 are operated by end-users or consumers, OCR system operators, and card issuer operators, respectively.

The user 101 can use the communication application 112, which may be, for example, a web browser application or a stand-alone application, to view, download, upload, or otherwise access documents or web pages via a distributed network 105. The network 105 includes a wired or wireless telecommunication system or device by which network devices (including devices 110, 120, and 170) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data, and/or messages.

The user computing device 110 may employ a communication application 112 to communicate with the web server 124 of the OCR system 120 or other servers. The communication application 112 may allow devices to communicate via technologies other than the network 105. Examples might include a cellular network, radio network, or other communication network.

The user computing device 110 may include a digital wallet application 111. The digital wallet application 111 may encompass any application, hardware, software, or process the user computing device 110 may employ to assist the user 101 in completing a purchase. The digital wallet application 111 can interact with the communication application 112 or can be embodied as a companion application of the communication application 112. As a companion application, the digital wallet application 111 executes within the communication application 112. That is, the digital wallet application 111 may be an application program embedded in the communication application 112. In certain embodiments a digital wallet of the user 101 may reside in a cloud computing environment, on a merchant server, or in any other environment.

The user computing device 110 may include an optical character recognition (“OCR”) application 115. The OCR application 115 may interact with the communication application 112 or be embodied as a companion application of the communication application 112 and execute within the communication application 112. In an exemplary embodiment, the OCR application 115 may additionally or alternatively be embodied as a companion application of the digital wallet application 111 and execute within the digital wallet application 111. The OCR application 115 may employ a software interface that may open in the digital wallet application 111 or may open in the communication application 112. The interface can allow the user 101 to configure the OCR application 115.

The OCR application 115 may be used to analyze a card 102 and extract information or other data from the card 102. The OCR system 120 or other system that develops the OCR algorithms or other methods may include a set of computer-readable program instructions, for example, using JavaScript, that enable the OCR system 120 to interact with the OCR application 115.

Any of the functions described in the specification as being performed by the OCR application 115 can be performed by the OCR system 120, the user computing device 110, the digital wallet application 111, a merchant system (not pictured) or any other suitable hardware or software system or application. In an example, the OCR application 115 on the user computing device 110 may obtain an image of a card 102 and transmit the image to the OCR system 120 to extract the information on the card 102.

The user computing device 110 includes a data storage unit 113 accessible by the OCR application 115, the communication application 112, or any suitable computing device or application. The exemplary data storage unit 113 can include one or more tangible computer-readable media. The data storage unit 113 can be stored on the user computing device 110 or can be logically coupled to the user computing device 110. For example, the data storage unit 113 can include on-board flash memory and/or one or more removable memory cards or removable flash memory.

The user computing device 110 may include a camera 114. The camera may be any module or function of the user computing device 110 that obtains a digital image. The camera 114 may be onboard the user computing device 110 or in any manner logically connected to the user computing device 110. The camera 114 may be capable of obtaining individual images or a video scan. Any other suitable image capturing device may be represented by the camera 114.

The user computing device 110 may include user applications 116. The user applications 116 may be contact applications, email applications, digital wallet applications 111, or any applications that may employ the name of the user 101 and/or names of acquaintances of the user 101. The user 101 may provide permission to the OCR application 115 to access the names and other data from the user applications 116. The OCR application 115 may use the data from the user applications 116 to verify or improve the OCR process.

A card issuer, such as a bank or other institution, may be the issuer of a financial account being registered. For example, the card issuer may be a credit card issuer, a debit card issuer, a stored value issuer, a financial institution providing an account, or any other provider of a financial account. A payment processing system (not pictured) also may function as the issuer for the associated financial account. The registration information of the user 101 is saved in the card issuer's data storage unit and is accessible by web server 174. The card issuer employs a card issuer system 170 to issue the cards, manage the user account, and perform any other suitable functions. The card issuer system 170 may alternatively issue cards used for identification, access, verification, ticketing, or cards for any other suitable purpose. The card issuer system 170 employs a web server 174 to allow a user 101 to register cards, to allow merchants to communicate with the card issuer system 170, to conduct transactions, or perform any other suitable tasks.

The OCR system 120 utilizes an OCR system web server 124 operating a system that produces, manages, stores, or maintains OCR algorithms, methods, processes, or services. The OCR system web server 124 may represent the computer-implemented system that the OCR system 120 employs to provide OCR services to user computing devices 110, merchant computing systems, or any suitable entity. The OCR system web server 124 can communicate with one or more payment processing systems, a user computing device 110, or other computing devices via any available technologies. Such technologies may include, for example, an Internet connection via the network 105, email, text, instant messaging, or other suitable communication technologies. The OCR system 120 may include a data storage unit 127 accessible by the web server 124 of the OCR system 120. The data storage unit 127 can include one or more tangible computer-readable storage devices.

In certain examples, any of the functions described in the specification as being performed by the OCR system 120 can be performed by the OCR application 115, the user computing device 110, or any other suitable hardware or software system or application.

Throughout the specification, the general term “card” will be used to represent any type of physical card instrument, such as the payment account card 102. In example embodiments, the different types of card 102 represented by “card” 102 can include credit cards, debit cards, stored value cards, loyalty cards, identification cards, or any other suitable card representing an account of a user 101 or other information thereon.

The user 101 may employ the card 102 when making a transaction, such as a purchase, ticketed entry, loyalty check-in, or other suitable transaction. The user 101 may obtain the card information for the purpose of importing the account represented by the card 102 into a digital wallet application 111 of a computing device 110 or for other digital account purposes. The card 102 is typically a plastic card containing the account information and other data on the card 102. In many card 102 embodiments, the customer name, expiration date, and card numbers are physically embossed on the card 102. The embossed information is visible from both the front and back of the card 102, although the embossed information is typically reversed on the back of the card 102.

It will be appreciated that the network connections shown are exemplary and other means of establishing a communications link between the computers and devices can be used. Moreover, those having ordinary skill in the art having the benefit of the present disclosure will appreciate that the user computing device 110, OCR system 120, and card issuer system 170 illustrated in FIG. 1 can have any of several other suitable computer system configurations. For example, a user computing device 110 embodied as a mobile phone or handheld computer may not include all the components described above.

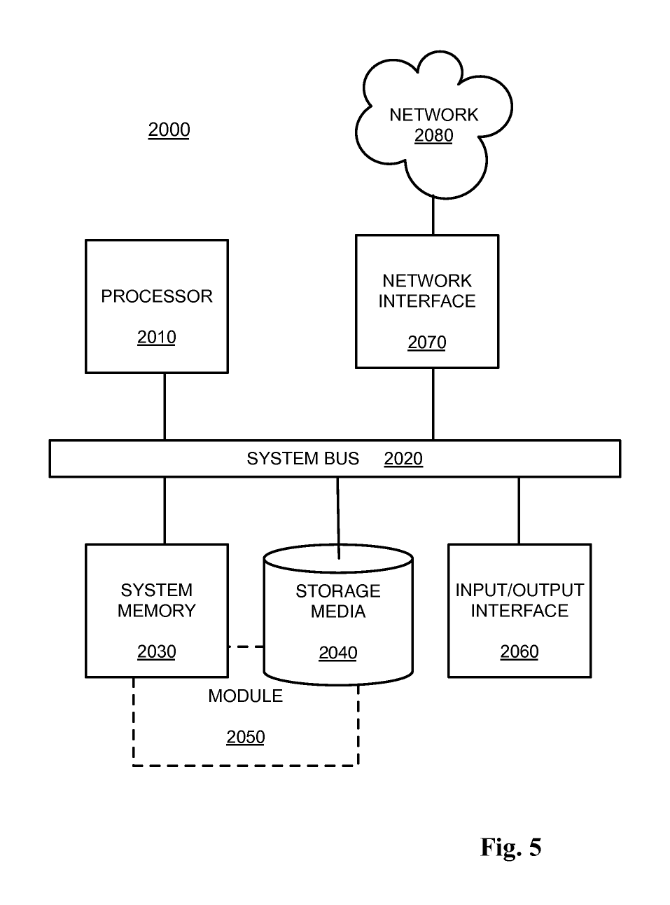

In example embodiments, the network computing devices and any other computing machines associated with the technology presented herein may be any type of computing machine such as, but not limited to, those discussed in more detail with respect to FIG. 5. Furthermore, any functions, applications, or modules associated with any of these computing machines, such as those described herein or any others (for example, scripts, web content, software, firmware, or hardware) associated with the technology presented herein may by any of the modules discussed in more detail with respect to FIG. 5. The computing machines discussed herein may communicate with one another, as well as with other computing machines or communication systems over one or more networks, such as network 105. The network 105 may include any type of data or communications network, including any of the network technology discussed with respect to FIG. 5.

### Example Processes

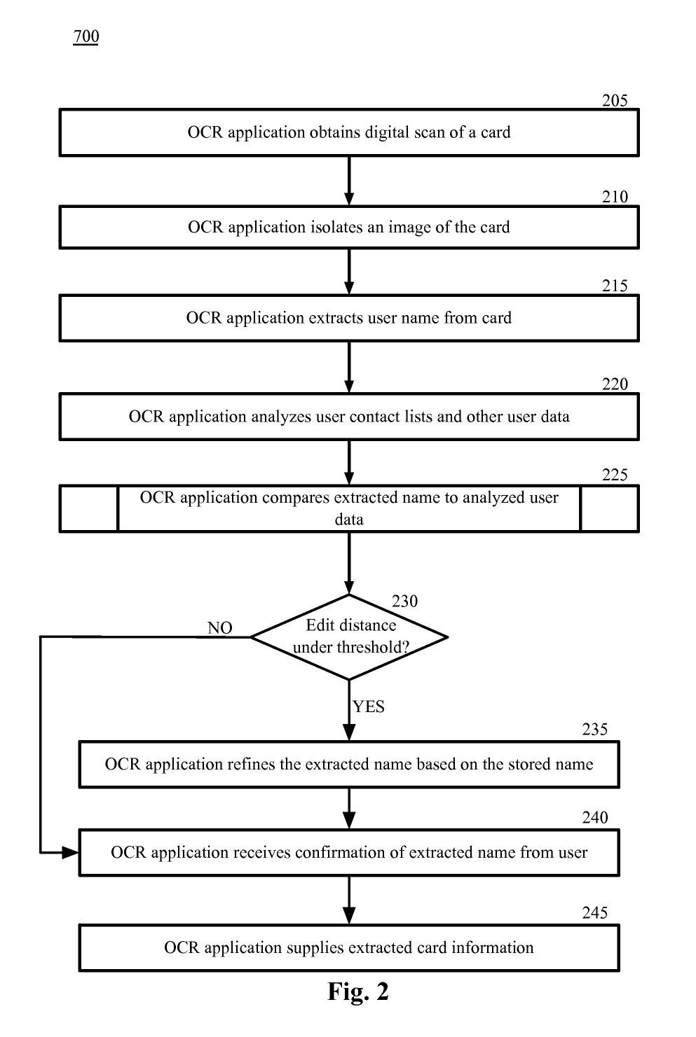

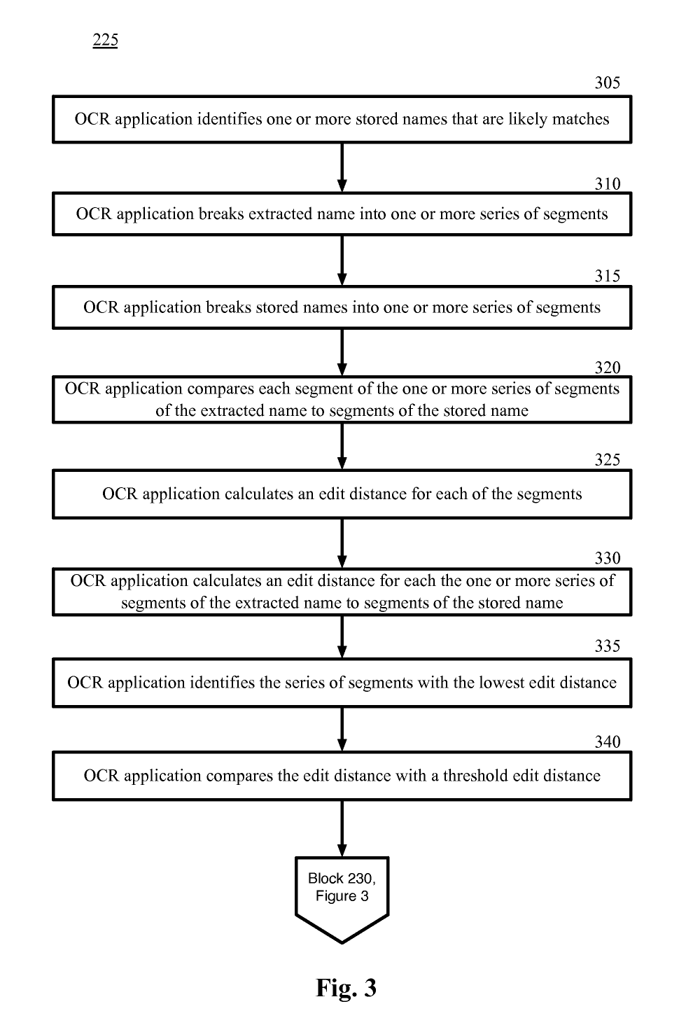

The example methods illustrated in FIGS. 2-3 are described hereinafter with respect to the components of the example operating environment 100. The example methods of FIGS. 2-3 may also be performed with other systems and in other environments.

FIG. 2 is a block flow diagram depicting a method 200 to use stored user names to verify and correct extracted user names, in accordance with certain exemplary embodiments.

With reference to FIGS. 1 and 2, in block 205, an optical character recognition (“OCR”) application 115 on the user computing device 110 obtains a digital scan or image of a payment account card 102. The user 101 employs a mobile phone, digital camera, or other user computing device 110 to capture an image of the card 102 associated with the account that the user 101 desires to input into the user computing device 110.

Throughout the specification, the general term “card” will be used to represent any type of physical card instrument, such as a magnetic stripe card. In example embodiments, the different types of instrument represented by “card” 102 can include credit cards, debit cards, stored value cards, loyalty cards, identification cards, or any other suitable card representing an account or other record of a user or other information thereon. Example embodiments described herein may be applied to the images of other items, such as receipts, boarding passes, tickets, and other suitable items. The card 102 may also be an image or facsimile of the card. For example, the card 102 may be a representation of a card on a display screen or a printed image of a card 102.

The user 101 may employ the card 102 when making a transaction, such as a purchase, ticketed entry, loyalty check-in, or other suitable transaction. The user 101 may obtain the card information for the purpose of importing the account represented by the card 102 into a digital wallet application 111 module of a computing device 110 or for other digital account purposes. The card 102 is typically a plastic card containing the account information and other data on the card 102. In many card 102 embodiments, the customer name, expiration date, and card numbers are physically embossed or otherwise written on the card.

A user 101 may desire to enter the information from the card 102 into a user computing device 110 or other computing device, for example, to conduct an online purchase, to conduct a purchase at a merchant location, to add the information to a digital wallet application 111 on a user computing device, or for any other suitable reason. In an example, the user 101 desires to use a user computing device 110 to conduct a purchase transaction using a digital wallet application 111 executing on the mobile computing device. The digital wallet application 111 may require an input of the details of a particular user payment account to conduct a transaction with the particular user payment account or to set up the account. Due to the small screen size and keyboard interface on a mobile device, such entry can be cumbersome and error prone for manual input. Additionally, a merchant system may need to capture card information to conduct a transaction or for other reasons.

An OCR application 115 on a user computing device 110 receives the image of the card 102 for the purposes of extracting the required information, such as the name of the user 102. The image may be obtained from the camera 114 or other digital image module of a user computing device 110, such as the camera 114 on a mobile phone. The image may be obtained from a scanner coupled to the user computing device 110 or any other suitable digital imaging device. The image may be obtained from video captured by the user computing device 110. The image may be accessed by the OCR application 115 on the user computing device 110 from a storage location on the user computing device 110, from a remote storage location, or from any suitable location. All sources capable of providing the image will be referred to herein as a “camera” 114.

An OCR application 115 receives the image of the card 102 from the camera 114. The functions of the OCR application 115 may be performed by any suitable module, hardware, software, or application operating on the user computing device. Some, or all, of the functions of the OCR application 115 may be performed by a remote server or other computing device, such as the server operating in an OCR system 120. For example, a digital wallet application 111 on the user computing device 110 may obtain the image of the card 102 and transmit the image to the OCR system 120 for processing. In another example, some of the OCR functions may be conducted by the user computing device 110 and some by the OCR system 120 or another remote server. Examples provided herein may indicate that many of the functions are performed by an OCR application 115 on the user computing device 110, but some or all of the functions may be performed by any suitable computing device.

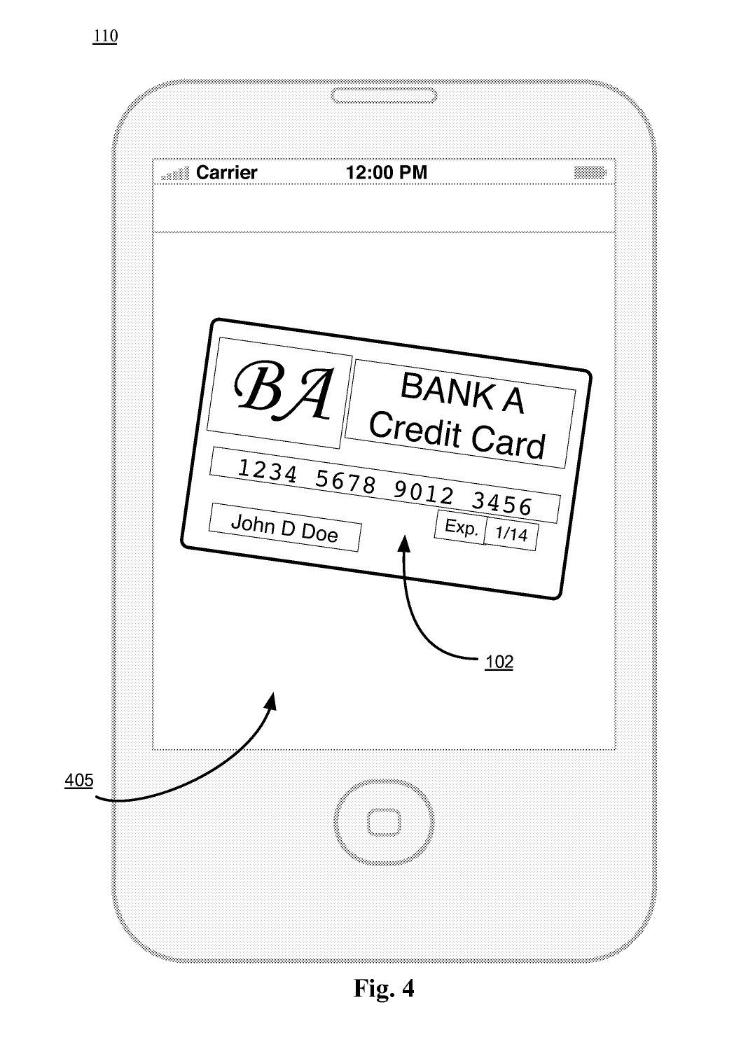

The image is presented on a user interface of the user computing device 110 as a live video image of the card 102 or a single image of the card 102. The OCR application 115 can isolate and store one or more images from the video feed of the camera 114. For example, the user 101 may hover the camera 114 function of a user computing device 110 over a card and observe the representation of the card on the user interface of the user computing device 110. An illustration of the card 102 displayed on the user computing device is presented in FIG. 4.

FIG. 4 is an illustration of a user computing device 110 displaying an image of a financial card 102, in accordance with certain example embodiments. The user computing device 110 is shown as a mobile smartphone. The user computing device 110 is shown with a display screen 405 as a user interface. The card 102 is shown displayed on the user computing device 110.

Returning to FIG. 2, in block 210, the OCR application 115 isolates the image of the card. Any image data manipulation or image extraction may be used to isolate the card image.

The OCR application 115, the camera 114, or the user computing device 110, or other computing device performs blur detection on the image. The image may be recognized as blurry, overly bright, overly dark, or otherwise obscured in a manner that prevents a high resolution image from being obtained. The OCR application 115, or other computing device, may adjust the image capturing method to reduce the blur in the image. For example, the OCR application 115 may direct the camera 114 to adjust the focus on the financial card. In another example, the OCR application 115 may direct the user to move the camera 114 closer to, or farther away from, the financial card. In another example, the OCR application 115 may perform a digital image manipulation to remove the blur. Any other suitable method of correcting a blurred image can be utilized.

In block 215, the OCR application 115 extracts the user name from the image of the card 102. The OCR application 115 applies an OCR algorithm to the card image to identify the information on the card 102. The OCR algorithm may represent any suitable process, program, method, or other manner of recognizing the digits or characters represented on the card image. The OCR algorithm may be customized to look for characters of the user name in particular locations on the card image. The OCR algorithm may be customized to look for certain combinations of characters. The OCR algorithm may be customized to know that the cards from the particular credit card company typically have certain data on the reverse side of the card 102. The OCR algorithm may be customized to know which characters are typically embossed. The OCR algorithm may be customized to look for any configured arrangements, data locations, limitations, card types, character configurations, or other suitable card data to identify the user name and other account information. The OCR application 115 may use a statistical language model to refine the result. A language model uses information about the probabilities of different characters and combines the characters to determine the most likely name. For example, if the results of the OCR algorithm returns a extracted name of “Anma,” the statistical language model will conclude that “Anna” is a more likely result and will update the result.

In block 220, the OCR application 115 analyzes user contact lists and other user data. The OCR application 115 accesses stored information associated with user 101 from the user computing device 110 and any other suitable location. The names may be extracted from contact lists, email applications, user social networks, and other suitable user applications 116, information from which may be stored on the user computing device 110, the OCR system 120, or another suitable location. In another example, the OCR application 115 accesses stored information associated with various user accounts, such as the digital wallet account, a financial payment account, or any other suitable account of the user 101. The OCR application 115 identifies names in the user data to be compared to the extracted name. For example, the OCR application 115 accesses the digital wallet account on the user computing device 110 and identifies the name of the user 101 associated with the digital wallet account. The name of the user 101 associated with the digital wallet account is likely to be the same name as the user name on the card 102.

In block 225, the OCR application 115 compares the extracted name to the analyzed user data. The details of block 225 are described in greater detail with respect to method 225 of FIG. 3.

FIG. 3 is a block flow diagram depicting methods to compare the extracted name to analyzed user data, in accordance with certain example embodiments. In block 305, the OCR application 115 identifies one or more stored names that are likely to be associated with the extracted name. The OCR application 115 identifies names that are repeated in the user data, such as names on user accounts managed on the user computing device 110. Alternatively, the OCR application 115 identifies names that are similar to the user name. For example, a spouse or other family members having the same surname of the user 101 may be represented frequently in the user data, such as on a contact list or a social network.

In block 310, the OCR application 115 breaks the extracted name into one or more series of segments. In an example, the segments are broken at each space in the extracted name. For example, in the name Jon A Smith, the segments might be broken into three segments, such as Jon/A/Smith. The stored names identified in the name recognition algorithm are broken into segments in a similar manner.

In another example, additional segment splits may be identified for the extracted name. For example, Jon A Smith may be segmented into Jon/A Smith, Jon A/Smith, or Jon/A/Smith or any other suitable grouping of segments.

In another example, certain letters may be worn off of the financial card and leave spaces in the extracted name, such as with the extracted name Jon A Sm th. The OCR application may divide the example extracted name into 1, 2, 3, or 4 segments. For example, the segments may be represented as Jon/A Sm/th, Jon A Sm/th, Jon/A Sm th, Jon/A/Sm th, Jon A/Sm th, Jon/A/Sm/th, or any other suitable series of segments.

In block 315, the OCR application 115 breaks the stored names into one or more series of segments. The segmenting of the stored names is performed in a similar method as the method for segementing the extracted name in block 310. Typically, the segments of the stored names are broken at each space in the name.

In block 320, the OCR application 115 compares each segment of the one or more series of segments of the extracted name to segments of the stored name. Each of the segments of the extracted names is compared to the segments of the stored names. For example, the OCR application 115 compares each letter of a segment of the extracted name to each letter of a segment of a stored name and determines if the letters are the same. If the letters are not the same, the differing letters are identified.

In block 325, the OCR application 115 calculates an edit distance for each of the segments. The OCR application 115 determines an edit distance between each segment in the comparison. In the example, if the first segment of a stored name is Jan, then the edit distance would be one letter. That is, changing the single letter “o” in Jon to an “a” would produce the stored name segment “Jan.” Changing a single letter would provide an edit distance of 1. The edit distance comparison may be performed for each segment of each of the series of segments. The segments may be compared to each of the stored names that were identified as being likely matches to the extracted name.

In block 330, the OCR application 115 calculates an overall edit distance for each of the one or more series of segments of the extracted name to segments of the stored name. The OCR application 115 calculates the overall edit distance for a series of segments by combining the edit distances of each of the individual segments of the series of segments. The edit distances may be added or have any other mathematical function applied to the segment edit distances. For example, a score, such as “90%” or “A,” may be produced based on the edit distances of each of the individual segments of the series of segments.

In certain examples, when calculating the overall edit distance, certain segments may be omitted from the calculation. In an example, the extracted user name is segmented into “Jon/Smith,” while the stored name is segmented into “Dr/Jon/A/Smith.” The segments “Jon” and “Smith” have an edit distance of 0, and the “Dr” and “A” segments from the stored name may be omitted for the purposes of calculating the overall edit distance, providing an overall edit distance of 0. In another example, skipped stored segments do not contribute to the overall edit distance, but extracted segments that do not have a corresponding stored name segment do contribute to the overall edit distance.

In an example, the extracted user name is segmented into “Jon/A/Smith,” while the stored name is segmented into “Dr/Jan/Smith.” The edit distances for “Jon” and “A” are each determined to be one. That is, one letter may be changed for each segment to create a match with the stored name. The segment “Dr” from the store name is omitted from the overall edit distance because the extracted name does not include a corresponding segment. Adding the required edit distances would create an overall edit distance of 2. Alternatively, a match score may be created based on the edit distances, such as a score of A, 90%, or any other suitable scoring system.

In an example, the edit distance is only measured in characters, and not in segments. For example, the edit distance would be counted as total edited characters and not include the number of edited segments. A correspondence between the segments of the extracted name and the stored name segments is established, so that every extracted name segment either has a corresponding stored name segment or is skipped, and similarly each stored name segment either has a corresponding extracted name segment or is skipped. The total edit distance is then computed by summing the edit distance between each pair of corresponding segments, and adding to that the total length of all extracted name segments that got skipped. That is, skipping stored name segments is not penalized and skipping the stored name segments does not add to the total edit distance.

As an example:

Extracted Name: Mr Jon Smith

Stored Name: Joe P Smithers

The edit distances would be as follows: “Mr” from the extracted name would have an edit distance of 2 because the segment is from the extracted name. “Jon” would have an edit distance of 1 compared to “Joe.” The “P” from the stored name would not contribute to the edit distance because the skipped segment is from the stored name. “Smith” would have an edit distance of 3 compared to “Smithers.”

Thus, the overall edit distance is 2+1+3=6.

In block 335, the OCR application 115 identifies the series of segments with the lowest edit distance. After calculating the overall edit distance or score from each of the series of segments as compared to each of the stored names that were identified as likely matches, the OCR application 115 identifies the series of segments with the lowest overall edit distance. In an example, if the extracted name is broken into segments as follows: Jon/A Smith, Jon A/Smith, or Jon/A/Smith. Jon/A Smith has an overall edit distance of three. Jon A/Smith has an overall edit distance of two. Jon/A/Smith has an overall edit distance of one. Thus, Jon/A/Smith has the lowest overall edit distance of the different series of segments.

In block 340, the OCR application 115 compares the edit distance with a threshold edit distance. After identifying the series with the lowest overall edit distance, the OCR application 115 compares the overall edit distance with a configured threshold. If the edit distance is below the threshold then the OCR application 115 revises the extracted name to match the identified stored name. In an example, the threshold overall edit distance is configured to be three. The threshold may be configured by the user 101, an operator of the OCR system 140, an operator of the card issuer system 170, or any other suitable person, system, or party. The threshold may be based on the calculated overall edit distance, a score based on the edit distances of the segments, or any other threshold based on the system used to assess the extracted user name.

From block 340, the method 225 returns to block 230 of FIG. 3.

In block 230, the OCR application 115 determines if the overall edit distance is below the configured threshold. If the overall edit distance is below the configured threshold, the method 200 proceeds to block 235.

In block 235, the OCR application 115 refines the extracted name based on the stored name. Because the stored name is presumed to be entered accurately by the user 101, the card issuer, or another person or system, the extracted name is revised to be consistent with the stored name. For example, if the extracted name is “Jon A. Smith” and the stored name is “Jan A. Smith,” then the OCR application 115 changes the extracted name to “Jan A. Smith.” Segments that did not appear in the extracted name may be left out of the revision or inserted. That is, if the extracted name is “Jon A. Smith” and the stored name is “Dr Jon H. Smith,” then the OCR application 115 may revise the extracted name to “Dr Jon H. Smith.” Alternatively, the OCR application 115 may only correct the extracted name to “Jon H. Smith,” and omit the “Dr.”

In certain examples, the complete extracted name is not revised to reflect the complete stored name. That is, the overall edit distance is not used to only accept or reject revision. Instead, individual extracted name segments may be revised if the individual extracted name segment has an edit distance below a configured threshold. Revising individual segments allows partial matches to be used. In an example, a user 101 scans a spouse's card using a user computing device 110. If the last name on the card matches the account name on a cell phone account associated with the user computing device 110, the OCR application 115 will perform a correction on the last name. However, if the first name does not match below a threshold, the first name will not be revised. For example, if the extracted name from the card is “Alice Smathers” and a stored name of “Jon Smithers” appears frequently in the user data, then the OCR application 115 may refine the extracted name to “Alice Smithers.”

In block 240, the OCR application 115 receives confirmation of extracted name from user 101. The OCR application 115 provides the refined name to the user 101 on a user interface of the user computing device 110 with instructions to verify or correct the name. For example, if the OCR application 115 incorrectly revised the extracted name, the user 101 may enter the correct name into the user interface.

From block 240, the method 200 proceeds to block 245.

Returning to block 230, if the overall edit distance is equal to or above the configured threshold, the method 200 proceeds to block 240. The OCR application 115 merely proceeds to provide an unrevised name to the user computing device 110 as described in block 235. That is, the OCR application 115 provides the uncorrected name to the user 101 on a user interface of the user computing device 110 with instructions to verify or correct the name. For example, if the OCR application 115 incorrectly extracted the extracted name, the user 101 may enter the correct name into the user interface.

In an alternative example, the method 200 returns to block 215 from block 230 if the edit distance is equal to or above the configured threshold. The method 200 may repeat the method of blocks 215, 220, 225, and 230 in an attempt to extract a user name that produces an overall edit distance that is below the threshold. In an example, the method 200 repeats the blocks 215, 220, 225, and 230 a limited number of attempts, such as 2, 5, or 10. In another example, the method 200 repeats the blocks 215, 220, 225, and 230 until the attempt is abandoned by the user 101, a suitable user name is obtained, or other instructions are received.

In block 245, the OCR application 115 supplies the extracted data to a digital wallet application 111, point of sale terminal, payment processing system, website, or any other suitable application or system that the user 101 authorizes. The extracted data may be used by an application on the user computing device 110, such as the digital wallet application 111. The extracted data may be transmitted via an Internet connection over the network 105, via a near field communication (“NFC”) technology, emailed, texted, or transmitted in any suitable manner.

### Example Systems

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a wearable computer, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read-only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to extract user names from financial cards and compare segments of the user names to names stored in user data to revise the extracted name, comprising:
receiving, by one or more computing devices, a digital image of a card;
applying, by the one or more computing devices, an optical character recognition algorithm to the digital image of the card to obtain an extracted name of a user associated with the card;
identifying, by the one or more computing devices, a name from stored user data that is likely to be associated with the extracted user name;
dividing, by the one or more computing devices, the extracted name into a series of segments;
dividing, by the one or more computing devices, the identified name into a series of segments;
comparing, by the one or more computing devices, the series of segments of the extracted name to the series of segments of the identified name;
calculating, by the one or more computing devices, an edit distance from the segments of the extracted names to series of segments of the identified name;
determining, by the one or more computing devices, that the edit distance is below a configured threshold; and
revising, by the one or more computing devices, one or more segments of the extracted name based on the identified name.

2. The method of claim 1, further comprising:
dividing, by the one or more computing devices, the extracted name into a plurality of series of segments, wherein each of the plurality of series of segments have different segment divisions;
comparing, by the one or more computing devices, each of the plurality of series of segments of the extracted name to the series of segments of the identified name;
selecting, by the one or more computing devices, one of the plurality of series of segments that has a shortest edit distance to the extracted name; determining, by the one or more computing devices, that the edit distance is below a configured threshold; and
revising, by the one or more computing devices, the extracted name based on the identified name.

3. The method of claim 1, wherein the extracted name and the identified name are divided into segments at each space in the name.

4. The method of claim 1, further comprising:
providing, by the one or more computing devices, the revised name to the user for verification or revision; and
receiving, by the one or more computing devices, an input of the revision from the user.

5. The method of claim 1, wherein the card comprises a credit card, a debit card, an identification card, a loyalty card, an access card, or a stored value card.

6. The method of claim 1, further comprising providing, by the one or more computing devices, the revised name to a digital wallet application on the one or more computing devices to use in a transaction.

7. The method of claim 1, wherein the edit distance is the number of characters in the extracted name segment that would require revising to match a corresponding identified name segment.

8. The method of claim 1, further comprising omitting, by the one or more computing devices, a segment from the extracted name if the segment does not have a corresponding segment in the identified name.

9. The method of claim 1, wherein the stored user data is from a contact list on the one or more computing devices.

10. The method of claim 1, wherein the stored user data is from an account of the user maintained on the one or more computing devices.

11. A computer program product, comprising:
a non-transitory computer-readable storage device having computer-executable program instructions embodied thereon that when executed by a computer cause the computer to extract user names from a financial cards and compare segments of the user names to names stored in user data to revise the extracted name, the computer-executable program instructions comprising:
computer-readable program instructions to receive a digital image of a financial card;
computer-readable program instructions to apply an optical character recognition algorithm to the digital image of the financial card to obtain an extracted name of a user associated with the card;
computer-readable program instructions to identify a name from stored user data that is likely to be associated with the extracted name;
computer-readable program instructions to divide the extracted name into a plurality of series of segments, wherein each of the plurality of series of segments have different segment divisions;
computer-readable program instructions to divide the identified name into a series of segments;
computer-readable program instructions to compare each of the plurality of series of segments of the extracted name to the series of segments of the identified name;
computer-readable program instructions to calculate an edit distance from the segments of the extracted names to series of segments of the identified name;
computer-readable program instructions to select one of the plurality of series of segments that has a shortest edit distance to the extracted name;
computer-readable program instructions to determining that the edit distance is below a configured threshold; and
computer-readable program instructions to revise the extracted name based on the identified name.

12. The computer program product of claim 11, wherein the extracted name and the identified name are divided into segments at each space in the name.

13. The computer program product of claim 11, further comprising computer-executable program instructions to reapply the optical character recognition algorithm to the digital image of the financial card upon a determination that the confidence level is below a preconfigured threshold.

14. The computer program product of claim 12, further comprising computer-readable program instructions to provide the revised name to a digital wallet application on a user computing device to use in a transaction.

15. The computer program product of claim 12, wherein the financial card comprises a credit card or a debit card.

16. The computer program product of claim 12, wherein the stored user data is from a contact list on the one or more computing devices.

17. A system to extract user names from a financial cards and compare segments of the user names to names stored in user data to revise the extracted name, comprising:
a storage device;
a processor communicatively coupled to the storage device, wherein the processor is configured to execute computer-readable instructions that are stored in the storage device to cause the system to:
receive a digital image of a card;
apply an optical character recognition algorithm to the digital image of the card to obtain an extracted name of a user associated with the card;
identify a name from stored user data that is likely to be associated with the extracted name;
divide the extracted name into a series of segments;
divide the identified name into a series of segments;
compare the series of segments of the extracted name to the series of segments of the identified name;
calculate an edit distance from the segments of the extracted names to series of segments of the identified name;
determine that the edit distance is below a configured threshold;
provide a revised name to a user for verification or revision, the revision being based on the identified name; and
receive a verification of the revision from the user.

18. The system of claim 17, wherein the edit distance is a number of characters in an extracted name segment that would require revising to match a corresponding identified name segment.

19. The system of claim 11, wherein the extracted name and the identified name are divided into segments at each space in the name.

20. The system of claim 11, wherein the stored user data is from an account of the user maintained on the processor.
